(19) United States
(12) Patent Application Publication
(10) Pub. No.: US 2025/0022486 A1
(43) Pub. Date: Jan. 16, 2025

(54) SYNCHRONIZING SOUND WITH VOLUMETRIC MEDIA CONTENTS

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(21) Appl. No.: 18/352,718

(22) Filed: Jul. 14, 2023

(51) Int. Cl. G11B 27/031

(52) U.S. Cl. CPC G11B 27/031

(57) ABSTRACT

A method is presented including capturing sounds from a plurality of objects within a volumetric video, analyzing the captured sounds to generate context of the captured sounds, determining whether to remove any existing sounds or to add any new sounds resulting in sound variations, dynamically modifying the volumetric video to synchronize the sound variations with the plurality of objects by employing a generative adversarial network (GAN) model, and generating a new volumetric video exhibiting synchronization between the plurality of objects and the sound variations.

### BACKGROUND

The present invention relates generally to volumetric video technology, and more specifically, to synchronizing sound with volumetric media content for virtual reality (VR) and augmented reality (AR) experiences.

Volumetric video technology leverages cameras and advanced data processing to render 3D images from a virtual space, which allows for video point of views to be generated from any angle within that space to create a more immersive experience for viewers. Volumetric capture involves using multiple cameras and sensors to film a subject, creating a full volume recording of the subject, rather than a flat image. Through post production, this captured volume data becomes a volumetric video, which is then viewable from any angle, with realistic depth, color and lighting, on any compatible platform, including mobile devices.

### SUMMARY

In accordance with an embodiment, a method for is provided. The method includes capturing sounds from a plurality of objects within a volumetric video, analyzing the captured sounds to generate context of the captured sounds, determining whether to remove any existing sounds or to add any new sounds resulting in sound variations, dynamically modifying the volumetric video to synchronize the sound variations with the plurality of objects by employing a generative adversarial network (GAN) model, and generating a new volumetric video exhibiting synchronization between the plurality of objects and the sound variations.

In accordance with another embodiment, a computer program product is provided, the computer program product comprising a computer readable storage medium having program instructions embodied therewith. The program instructions are executable by a computer to cause the computer to capture sounds from a plurality of objects within a volumetric video, analyze the captured sounds to generate context of the captured sounds, determine whether to remove any existing sounds or to add any new sounds resulting in sound variations, dynamically modify the volumetric video to synchronize the sound variations with the plurality of objects by employing a generative adversarial network (GAN) model, and generate a new volumetric video exhibiting synchronization between the plurality of objects and the sound variations.

In accordance with yet another embodiment, a system is provided. The system includes a memory and one or more processors in communication with the memory configured to capture sounds from a plurality of objects within a volumetric video, analyze the captured sounds to generate context of the captured sounds, determine whether to remove any existing sounds or to add any new sounds resulting in sound variations, dynamically modify the volumetric video to synchronize the sound variations with the plurality of objects by employing a generative adversarial network (GAN) model, and generate a new volumetric video exhibiting synchronization between the plurality of objects and the sound variations.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of an exemplary audio and image synchronization in volumetric video architecture, in accordance with an embodiment of the present invention;

FIG. 2 is a block/flow diagram of an exemplary generative adversarial network (GAN) model for changing volumetric video visual content, in accordance with an embodiment of the present invention;

FIG. 3 is a block/flow diagram of an exemplary method for generating new volumetric media content by creating a knowledge corpus based on different types of sounds, in accordance with an embodiment of the present invention;

FIG. 4 is a block/flow diagram of an exemplary method for generating new volumetric media content by identifying context of the audio based on the sounds, in accordance with an embodiment of the present invention;

FIG. 5 is a block/flow diagram of an exemplary method for generating new volumetric media content by determining if existing objects in the volumetric media content can affect the additional context added to the audio, in accordance with an embodiment of the present invention; and

FIG. 6 is a block diagram of an exemplary computer system to apply the audio and image synchronization in volumetric video architecture, in accordance with an embodiment of the present invention.

Throughout the drawings, same or similar reference numerals represent the same or similar elements.

### DETAILED DESCRIPTION

Embodiments in accordance with the present invention provide methods and systems for synchronizing sound with volumetric media content for virtual reality (VR) and augmented reality (AR) experiences. Volumetric video is an emerging media format that captures a subject in three dimensions but allows playback from any conceivable angle. Volumetric video is different than 3D movies or 360-degree video in that a user can experience a recording with six degrees of freedom (6DoF), including X, Y, and Z axes, in addition to pitch, yaw, and roll. This freedom allows users to experience, rather than watch, a recorded event through VR or AR headsets. Most people are familiar with holograms, which accurately reflect the output of a volumetric video. Volumetric video captures actors or subjects in 3D to create holograms that viewers can watch from any conceivable angle. Users would consume volumetric videos through the use of virtual VR or AR devices. Depth-sensing cameras paired with a traditional camera to capture color can capture volumetric video. The depth camera captures depth by analyzing infrared light and generating a 3D mesh of the subject.

However, while editing volumetric video, in many scenarios, existing audio can be removed or new audio can be added. For example, sounds of nature can be added and sounds of vehicles can be removed from the volumetric video. Sound is omni-directional, but sound properties can be changed based on various parameters such as humidity, Doppler effect, distance from any object, etc. Therefore, appropriate synchronization of audio and images in any volumetric video is needed.

To address such editing issues, the exemplary embodiments analyze the volumetric video content, as well as changes in the sound, and compare the images of the volumetric video content with the simulated content of the sound to identify appropriate changes in volumetric video and create generative adversarial network (GAN) rules for adapting the volumetric video. The example embodiments identify if existing objects are to be altered based on the sound modifications. The example embodiments further identify if any sound is related to an activity performed by the one or more objects, and if a sound should be added, then existing objects are modified to show the activity being performed, or if the activity sound is removed, then the image is modified so that the activity is stopped. If the sound property is altered, then existing objects are altered in relation to the mobility speed on the video.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

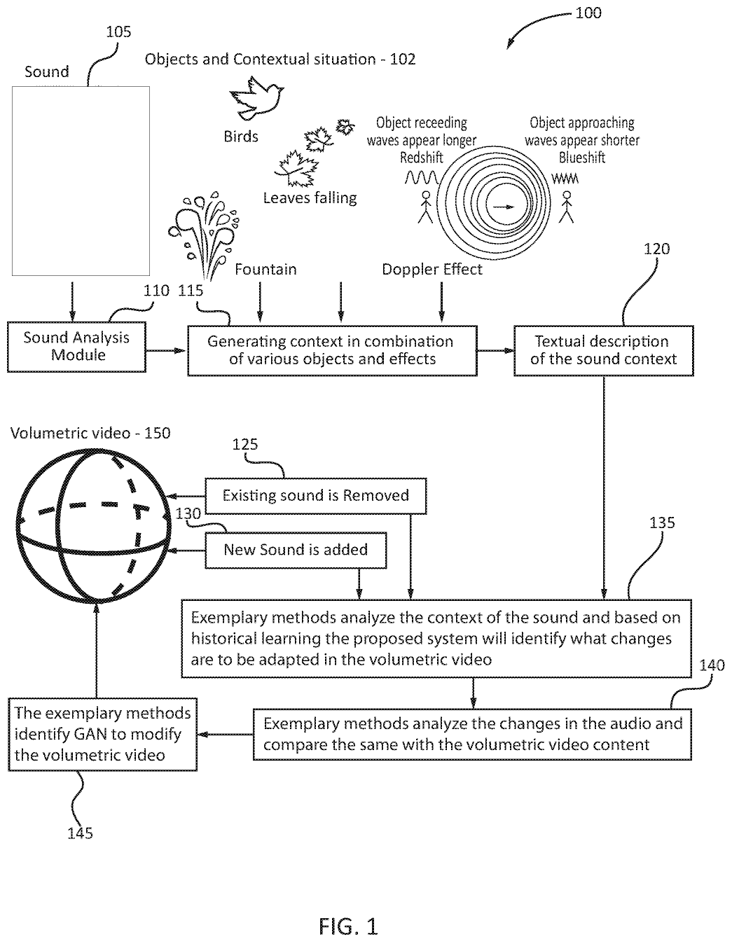

FIG. 1 is a block/flow diagram of an exemplary audio and image synchronization in volumetric video architecture, in accordance with an embodiment of the present invention.

In the audio and image synchronization in volumetric video architecture 100, sounds 105 are detected from objects 102. The objects 102 can be, for example, birds or falling leaves or a water fountain or objects generating a Doppler effect.

The Doppler effect is an apparent change in frequency of a wave in relation to an observer moving relative to the wave source. A common example of the Doppler effect is the change of pitch heard when a vehicle sounding a horn approaches and recedes from an observer. Compared to the emitted frequency, the received frequency is higher during the approach, identical at the instant of passing by, and lower during the recession. The reason for the Doppler effect is that when the source of the waves is moving towards the observer, each successive wave crest is emitted from a position closer to the observer than the crest of the previous wave. Therefore, each wave takes slightly less time to reach the observer than the previous wave. Hence, the time between the arrivals of successive wave crests at the observer is reduced, causing an increase in the frequency. While they are traveling, the distance between successive wave fronts is reduced, so the waves “bunch together.” Conversely, if the source of waves is moving away from the observer, each wave is emitted from a position farther from the observer than the previous wave, so the arrival time between successive waves is increased, thus reducing the frequency. The distance between successive wave fronts is then increased, so the waves “spread out.” Thus, in the instant case, object receding waves appear longer and object approaching waves appear shorter as illustrated in FIG. 1.

The sounds 105 are analyzed by a sound analyzer 110. The sound analyzer 110 generates context in combination of various objects and effects. This can be referred to as a context generator 115. The output of the context generator 115 is provided to a textual descriptor 120. The textual descriptor 120 provides a textual description of the sound context.

In one example, existing sounds can be removed by a sound remover 125. In another example, new sounds can be added by a sound adder 130.

In block 135, the exemplary methods analyze the context of the sound and based on historical learning, the exemplary system identifies what changes are to be adapted in the volumetric video. Block 135 receives the textual descriptions of the sound context from the textual descriptor 120 and also receives sounds to be removed by the sound remover 125 and sounds to be added by the sound adder 130.

In block 140, the exemplary methods analyze the changes in the audio and compare the same with the volumetric video content. The output of block 140 is provided to GAN 145. The exemplary methods employ the GAN 145 to modify the volumetric video. Then the volumetric video 150 is generated.

Therefore, the volumetric video is updated by adding or removing audio content, and, accordingly, based on the updates of the audio content, the exemplary system uses the GAN 145 to modify the images on the volumetric video and make the same aligned or synchronized with images of the volumetric video.

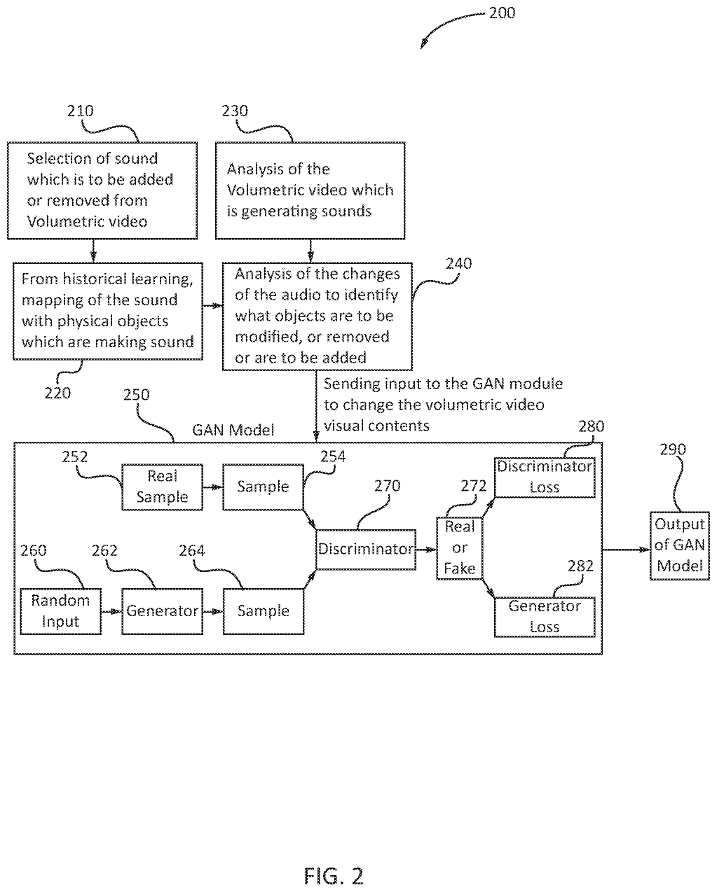

FIG. 2 is a block/flow diagram of an exemplary generative adversarial network (GAN) model for changing volumetric video visual content, in accordance with an embodiment of the present invention.

GANs are an approach to generative modeling using deep learning methods, such as convolutional neural networks (CNNs). Generative modeling is an unsupervised learning task in machine learning that involves automatically discovering and learning the regularities or patterns in input data in such a way that the model can be used to generate or output new examples that plausibly could have been drawn from the original dataset.

GANs are a way of training a generative model by framing the problem as a supervised learning problem with two sub-models, that is, the generator model that is trained to generate new examples, and the discriminator model that tries to classify examples as either real (from the domain) or fake (generated). The two models are trained together in a zero-sum game, adversarial, until the discriminator model is fooled about half the time, meaning the generator model is generating plausible examples.

Referring back to FIG. 2, and the system 200, the GAN 250 receives inputs to change the volumetric video visual contents.

At block 210, selection of sound which is to be added or removed from the volumetric video takes place.

At block 220, from historical learning, mapping of the sound with physical objects which are making sounds takes place.

At block 230, analysis of the volumetric video is performed which generates the sounds.

At block 240, analysis of the changes of the audio to identify what objects are to be modified or removed or are to be added takes place.

The data from blocks 210, 220, 230, 240 are sent as input to the GAN 250.

The GAN 250 has real samples 252 which are presented as samples 254 to the discriminator 270. The GAN 250 has random inputs 260 provided to the generator 262 which are presented as samples 264 to the discriminator 270.

The generator 262 learns to generate plausible data. The generated instances become negative training examples (e.g., the samples 264) for the discriminator 270. The samples 254 are the real data.

The discriminator 270 learns to distinguish the generator's fake data from the real data (e.g., the samples 254). The discriminator 270 penalizes the generator 262 for producing implausible results. The discriminator 270 determines whether the data is real or fake by employing the comparator 272. When training begins, the generator 262 produces obviously fake data (e.g., the samples 264), and the discriminator 270 quickly learns to tell that such data is fake. As the training progresses, the generator 262 gets closer to producing output that can fool the discriminator 270. Finally, if generator training goes well, the discriminator 270 gets worse at telling the difference between real and fake data or images. The discriminator 270 starts to classify fake data as real data, and its accuracy decreases. This is referred to as a discriminator loss 280 and a generator loss 282. The output is designated as 290.

Both the generator 262 and the discriminator 270 are neural networks. The generator output is connected directly to the discriminator input. Through backpropagation, the discriminator's classification provides a signal that the generator 262 uses to update its weights. Stated differently, the generator 262 and the discriminator 270 are both neural networks and they both run in competition with each other in the training phase. The steps are repeated several times and in this case, the generator 262 and the discriminator 270 get better and better in their respective jobs after each repetition.

Therefore, FIG. 2 presents how the volumetric video is adapted based on the alteration of the sound properties from the volumetric video.

In accordance with FIGS. 1 and 2, based on historical analysis of different types of sources of sounds (e.g., animals, birds, vehicles, etc.), and the patterns of sound generation (e.g., loudness, etc.), the exemplary system identifies a distance of different types of sources which are generating sound, and, accordingly, if any existing sound is removed or if any new sound is added with any volumetric video, then the exemplary system dynamically adapts the volumetric video aligned with the changes in the sound.

In one embodiment, if any new sound is added with the volumetric video, then the exemplary system identifies if any existing objects on the volumetric video are to be adapted to show the effect of the sound, or new objects are to be added with the volumetric video.

In another embodiment, based on historical analysis of different types of activities, such as falling leaves, water fountains, screaming of crowds, etc., the exemplary system correlates the activities of different objects with the pattern of sound generation, and, accordingly, based on removal or addition of sound within the volumetric video, the exemplary system dynamically adapts the volumetric video to be aligned with the changes in the sound.

In yet another embodiment, the exemplary system also analyzes the effect on the sound, which is to be added or removed, such as the Doppler effect, echo of the sound, and, accordingly, creates appropriate mobility and speed of mobility and direction of the mobility among the sound generated objects, so that the audio is aligned or synchronized with the volumetric video content.

As a result, the exemplary system analyzes the volumetric video content, and changes in the sound, and compares the images of the volumetric video content with the simulated content of the sound, and further identifies appropriate changes in volumetric video and creates GAN rules for adapting the volumetric video.

In practical applications, while capturing a volumetric video, certain noises are also captured, such as sounds from a running vehicle, and the vehicle is visible as running on the volumetric video, birds are screaming etc. These sounds need to be removed. In such practical application, the vehicle should be shown in a stopped condition and the beak of the birds should not be moving. Both the vehicles and birds should be removed. This adaptation can be performed with GAN. Based on the alteration of the sound of the crowd, the exemplary methods dynamically alter the crowd density to be aligned with the sound. Thus, an artificial intelligence (AI) system can map the crowd density and the sound generated. In other words, the GAN is used to remove the sound that the bird is making and the GAN is used to modify the car by presenting the car in a stopped condition not generating any sound or by removing density within a crowd to thin out the crowd.

In accordance with this practical application, if any new sound is added with the volumetric video, then the exemplary system identifies if any existing objects on the volumetric video are to be adapted (or modified) to show the effect of the sound, or new objects are to be added with the volumetric video. For example, the vehicle can be showed as stopped, but the sound of the vehicle is added. Or if a bird is sitting idle, then the sound of the bird is added, so that the bird starts moving its beak. As a result, the exemplary methods perform digital simulation of the sound to identify if any sound is related to the activity (performed by one or more objects within the volumetric video), the sound effects, and the environmental parameters, and, accordingly, the existing objects are modified with a GAN model to create alignment or synchronization with addition and/or removal of sounds or altering the properties of the sound.

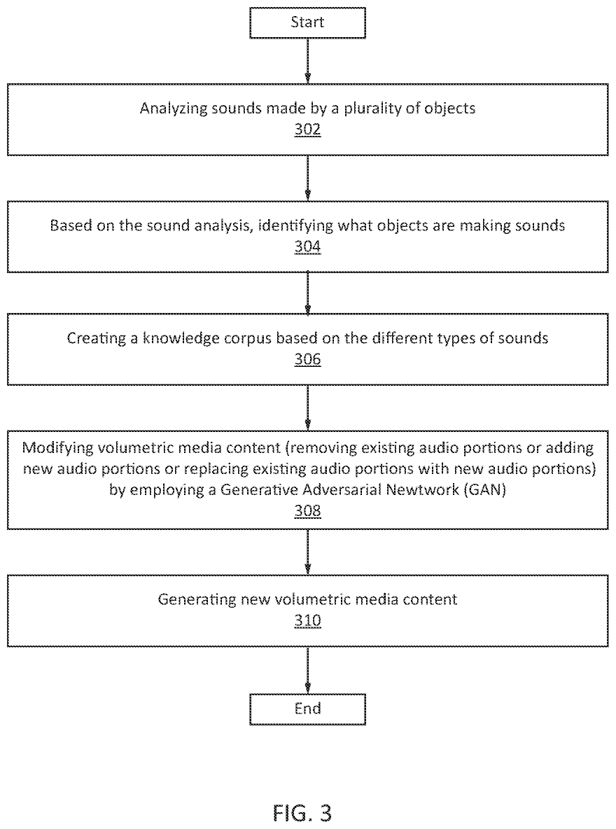

FIG. 3 is a block/flow diagram of an exemplary method for generating new volumetric media content by creating a knowledge corpus based on different types of sounds, in accordance with an embodiment of the present invention.

At block 302, analyze sounds made by a plurality of objects.

At block 304, based on the sound analysis, identify what objects are making sounds.

At block 306, create a knowledge corpus based on the different types of sounds.

At block 308, modify volumetric media content (by removing existing audio portions or adding new audio portions or replacing existing audio portions with new audio portions) by employing a Generative Adversarial Network (GAN).

At block 310, generate new volumetric media content.

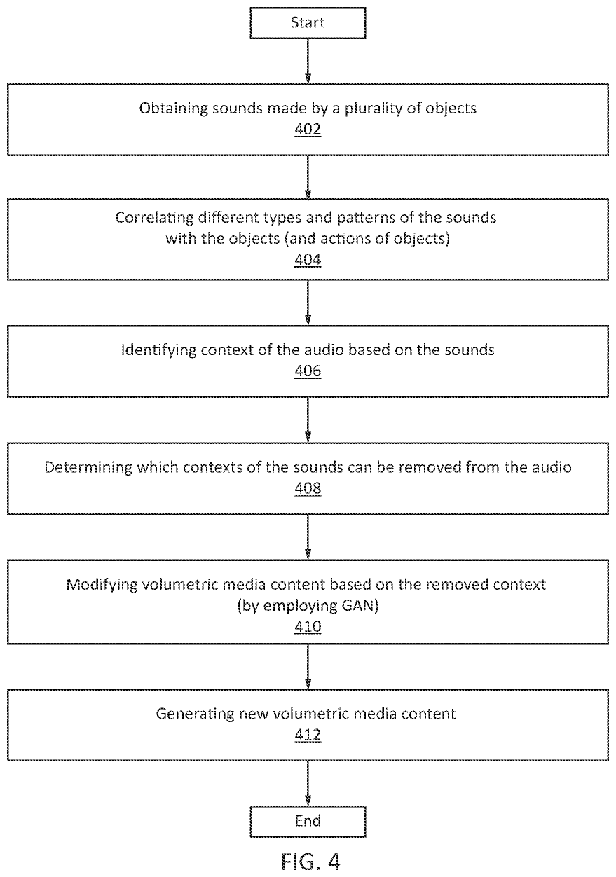

FIG. 4 is a block/flow diagram of an exemplary method for generating new volumetric media content by identifying context of the audio based on the sounds, in accordance with an embodiment of the present invention.

At block 402, obtain sounds made by a plurality of objects.

At block 404, correlate different types and patterns of the sounds with the objects (and actions of objects).

At block 406, identify context of the audio based on the sounds.

At block 408, determine which contexts of the sounds can be removed from the audio.

At block 410, modify volumetric media content based on the removed context (by employing GAN).

At block 412, generate new volumetric media content.

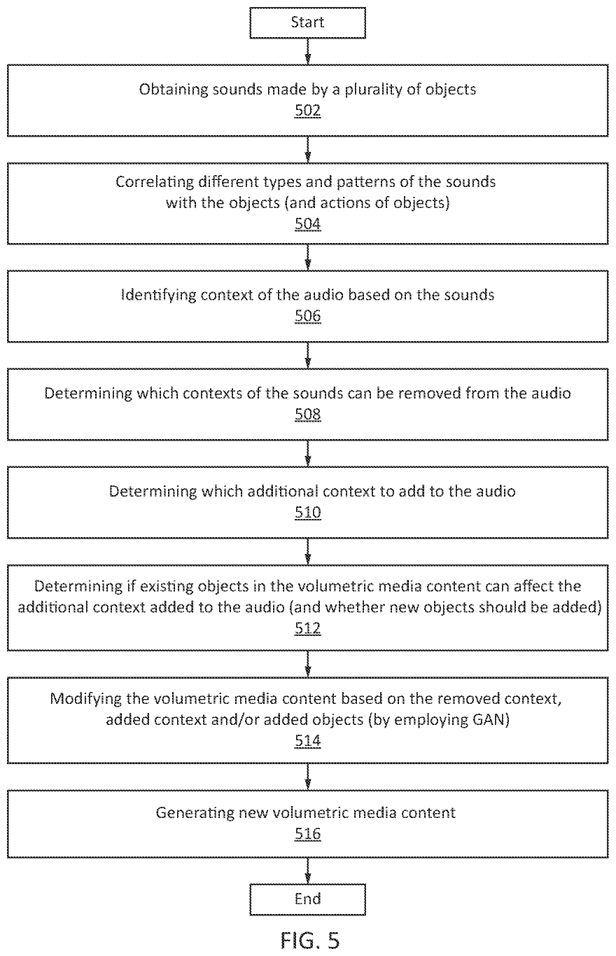

FIG. 5 is a block/flow diagram of an exemplary method for generating new volumetric media content by determining if existing objects in the volumetric media content can affect the additional context added to the audio, in accordance with an embodiment of the present invention.

At block 502, obtain sounds made by a plurality of objects.

At block 504, correlate different types and patterns of the sounds with the objects (and actions of objects).

At block 506, identify context of the audio based on the sounds.

At block 508, determine which contexts of the sounds can be removed from the audio.

At block 510, determine which additional context to add to the audio.

At block 512, determine if existing objects in the volumetric media content can affect the additional context added to the audio (and whether new objects should be added).

At block 514, modify the volumetric media content based on the removed context, added context and/or added objects (by employing GAN).

At block 516, generate new volumetric media content.

In conclusion, embodiments in accordance with the present invention provide methods and systems for synchronizing sound with volumetric media content for virtual reality (VR) and augmented reality (AR) experiences.

In one embodiment, based on historical information related to different video and audio, the exemplary system correlates different types and patterns of sounds with objects, and actions of the objects.

In another embodiment, the exemplary system can use convolutional neural networks (CNNs) to perform image analysis from various videos and images, and correlate the objects in the images with the sounds.

In an embodiment, the exemplary system performs analysis of sound to identify if the sound is having any effect, such as the doppler effect. Based on the analysis of the sound, the exemplary system identifies what types of objects are making sounds and compares the same with the effect.

In an embodiment, the exemplary system creates a knowledge corpus on different types of sounds that are generated from different objects, having actions among the objects, etc., and also identifies the effect of the objects. The exemplary system identifies existing audio or sound with any volumetric video content and analyzes the sound.

In an embodiment, while modifying any volumetric media content, the editor can remove existing audio and can also add additional audio or replace existing audio with new audio. The exemplary system identifies what audio is to be removed from the volumetric video and identifies which portions of the audio are to be removed. The exemplary system analyzes the audio portions to be removed, and using the knowledge corpus, identifies which objects are generating the sounds and effects. Based on the analysis of the sounds, the exemplary system identifies context of the audio, and removes the audio from the volumetric video. Thus, the exemplary system identifies the context to be removed from the volumetric video and extracts the context of the volumetric video.

In an embodiment, based on removal of the audio/sound from the volumetric video, the exemplary system removes the context from the volumetric video. The exemplary system identifies which objects, and which contexts, are to be removed from the volumetric video. The exemplary system identifies the changes in the volumetric video image contents and uses GAN to modify the volumetric video. The editor can also add one or more audio clips within the volumetric video, and analyze the audio contents which are to be added.

In an embodiment, the exemplary system identifies which additional context is to be added with the volumetric video, and identifies if existing image objects on the volumetric video can change the context of the newly added video or new objects are to be added. The exemplary system identifies which existing image object contents are to create context or new objects are to be added, and identifies the needed changes or modifications. The exemplary system makes appropriate changes with the GAN model and identifies which objects are to be changed in the volumetric video. The exemplary system further identifies the distance of the objects which are generating sound, and, accordingly, the volumetric video is updated with appropriate positions and distances of the objects which are generating the sounds.

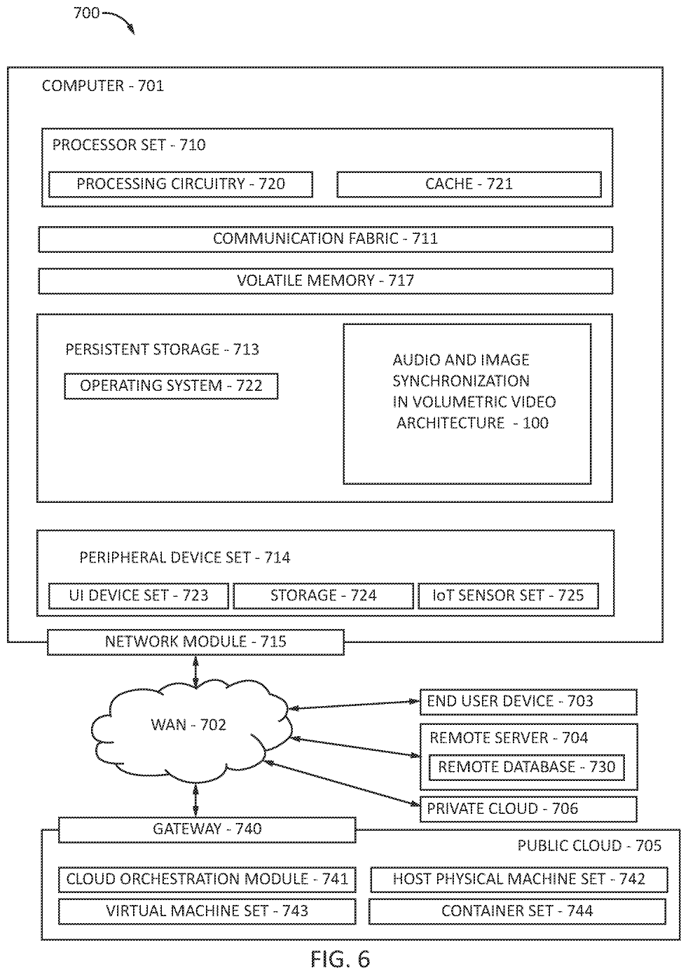

FIG. 6 is a block diagram of an exemplary computer system to apply the apply the audio and image synchronization in volumetric video architecture, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the audio and image synchronization in volumetric video architecture 100. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 6. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of methods and devices for synchronizing sound with volumetric media content for virtual reality (VR) and augmented reality (AR) experiences (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
capturing sounds from a plurality of objects within a volumetric video;
analyzing the captured sounds to generate context of the captured sounds;
determining whether to remove any existing sounds or to add any new sounds resulting in sound variations;
dynamically modifying the volumetric video to synchronize the sound variations with the plurality of objects by employing a generative adversarial network (GAN) model; and
generating a new volumetric video exhibiting synchronization between the plurality of objects and the sound variations.

2. The method of claim 1, wherein a knowledge corpus is created based on the captured sounds.

3. The method of claim 1, wherein the captured sounds are correlated with the plurality of objects and correlated with actions taken by the plurality of objects.

4. The method of claim 1, wherein the context of the captured sounds is based on effects on the captured sounds including a Doppler effect or sound echoes.

5. The method of claim 1, wherein additional context is added to the volumetric video based on movements of the plurality of objects within the volumetric video.

6. The method of claim 1, wherein a distance of the plurality of objects generating the sounds is determined when dynamically modifying the volumetric video to synchronize the sound variations with the plurality of objects.

7. The method of claim 1, wherein digital simulations of the sounds are performed to identify any sound that is related to an activity produced by one or more of the plurality of objects, sound effects, and environmental parameters.

8. A computer program comprising a computer readable storage medium having program instructions embodied therewith, the program instructions executable by a computer to cause the computer to:
capture sounds from a plurality of objects within a volumetric video;
analyze the captured sounds to generate context of the captured sounds;
determine whether to remove any existing sounds or to add any new sounds resulting in sound variations;
dynamically modify the volumetric video to synchronize the sound variations with the plurality of objects by employing a generative adversarial network (GAN) model; and
generate a new volumetric video exhibiting synchronization between the plurality of objects and the sound variations.

9. The computer program product of claim 8, wherein a knowledge corpus is created based on the captured sounds.

10. The computer program product of claim 8, wherein the captured sounds are correlated with the plurality of objects and correlated with actions taken by the plurality of objects.

11. The computer program product of claim 8, wherein the context of the captured sounds is based on effects on the captured sounds including a Doppler effect or sound echoes.

12. The computer program product of claim 8, wherein additional context is added to the volumetric video based on movements of the plurality of objects within the volumetric video.

13. The computer program product of claim 8, wherein a distance of the plurality of objects generating the sounds is determined when dynamically modifying the volumetric video to synchronize the sound variations with the plurality of objects.

14. The computer program product of claim 8, wherein digital simulations of the sounds are performed to identify any sound that is related to an activity produced by one or more of the plurality of objects, sound effects, and environmental parameters.

15. A system comprising:
a memory; and
one or more processors in communication with the memory configured to:
capture sounds from a plurality of objects within a volumetric video;
analyze the captured sounds to generate context of the captured sounds;
determine whether to remove any existing sounds or to add any new sounds resulting in sound variations;
dynamically modify the volumetric video to synchronize the sound variations with the plurality of objects by employing a generative adversarial network (GAN) model; and
generate a new volumetric video exhibiting synchronization between the plurality of objects and the sound variations.

16. The system of claim 15, wherein the captured sounds are correlated with the plurality of objects and correlated with actions taken by the plurality of objects.

17. The system of claim 15, wherein the context of the captured sounds is based on effects on the captured sounds including a Doppler effect or sound echoes.

18. The system of claim 15, wherein additional context is added to the volumetric video based on movements of the plurality of objects within the volumetric video.

19. The system of claim 15, wherein a distance of the plurality of objects generating the sounds is determined when dynamically modifying the volumetric video to synchronize the sound variations with the plurality of objects.

20. The system of claim 15, wherein digital simulations of the sounds are performed to identify any sound that is related to an activity produced by one or more of the plurality of objects, sound effects, and environmental parameters.
